(19) United States
(12) Patent Application Publication
(10) Pub. No.: US 2002/0162254 A1
(43) Pub. Date: Nov. 7, 2002

(54) Card for viewing an image

(76) Inventor: Jaap Boon, Delft (NL)

Correspondence Address: DANIEL H. GOLUB, 1701 MARKET ST., PHILADELPHIA, PA, 19103, US

(21) Appl. No.: 09/848,776

(22) Filed: May 4, 2001

(51) Int. Cl. G09F 1/00

(52) U.S. Cl. 40/124.01

(57) ABSTRACT

A greeting card which allows for the viewing of an image is provided. The card is a substantially tubular, flexible structure. The structure has a face area, including an eye area and nose area. One or more magnifying lenses are integrally mounted to the structure in the face area. Two one images are deposited on the inside surface of the structure, opposite the face area, next to each other. A viewer places his or her eyes in near contact with the magnifying lenses and views the image. The image may also be viewed in three dimensions.

### CROSS-REFERENCE TO RELATED APPLICATIONS

Not Applicable.

### STATEMENT REGARDING FEDERALLY SPONSORED RESEARCH

Not Applicable.

### BACKGROUND OF THE INVENTION

1. Field of the Invention

The disclosed invention relates generally to a card, such as a greeting card, which allows for viewing of an image.

2. Description of the Background

Various types of greeting cards are known in the art. The most well-known and widely purchased greeting cards consist of single- or double-ply paper, folded down the center such that they open like a book, with an image on the front and text inside. Given the high demand for greeting cards and the millions of cards that are purchased each year, there exists a need for an alternative to the traditional center-fold card for those members of the consuming public that are looking for something different. One prior art proposal for an alternative greeting card is shown in WIPO Certificate of Deposit of Industrial Designs DM/032,970. This tube shaped greeting card allowed a user to look through the eye holes provided and view an image included on the inside of the card. However, no lenses were included in DM/032,970 to enhance the user's ability to view the image. Thus, there exists a need for a greeting card which provides an alternative to a traditional, center-fold greeting card but which represents and improvement over the prior art.

### SUMMARY OF THE INVENTION

The present invention is directed to a greeting card for viewing an image, which includes a substantially tubular flexible structure which has a front side having a face portion and a back side having an inner surface (the front side opposing the back side), a top side and a bottom side. The substantially tubular structure may be formed of six planar surfaces. The top side and the bottom side are flexible. The face portion defines an eye area, a nose area and at least one tab accepting area. At least one image is deposited on the inner surface, opposite the face portion. The image deposited on the inner surface may include one or more pictures attached to the structure or ink printed onto the structure. At least one magnifying lens is also provided which includes at least one tab. The at least one lens is integrally mounted in the structure by inserting the tab in the tab accepting area.

In one aspect of the present invention, a first image and a second image are deposited on the inner surface. The first image is disposed next to the second image, and oriented on the inner surface substantially level with the second image relative to the bottom side. In another aspect of the invention, the greeting card comprises two magnifying lenses, and further comprises a bridge connecting the two lenses. The tab is held in the tab accepting area by a force supplied by a bending of the bridge. In a further aspect, when the first and second images are viewed through the two magnifying lenses, a single three-dimensional image is presented to a viewer. In yet a further aspect, the image is brought into focus by compressing the top side and the bottom side, thereby varying a distance between the front and back sides.

The present invention is also directed to a method of creating a greeting card for viewing an image comprising. In one step of the method, a substantially tubular flexible structure is provided (which includes a front side and a back side having an inner surface, wherein the front side opposes the back side) having a face portion, a top side and a bottom side. The top side and the bottom side are flexible and, in one aspect, are formed of planar surfaces. The face portion defines an eye area, a nose area and at least one tab accepting area. In another step of the method, at least one image is deposited on the inner surface (which, in one aspect, may include one or more pictures attached to the structure or ink printed onto the structure), opposite the face portion. In one aspect of the invention, a first image and a second image are deposited on the inner surface, wherein the first image is disposed next to the second image, and oriented on the inner surface substantially level with the second image relative to the bottom side. In a further step of the method, at least one magnifying lens (which includes at least one tab) is integrally mounted in the structure by inserting the tab in the tab accepting area. In one aspect of the invention, two lenses are provided and the method includes the additional step of connecting the two lenses with a bridge, wherein the tab is inserted into the tab accepting area by bending the bridge.

In one aspect of the invention, when the first and second images are viewed through the two magnifying lenses, a single three-dimensional image is presented to a viewer. In another aspect of the invention, the method includes the further step of focussing the image by compressing the top side and the bottom side, thereby varying a distance between the front and back sides.

The present invention is further directed to a method for viewing an image through a greeting card. In one step of the method, one or more eyes of a viewer are placed in near contact with at least one magnifying lens. The lens comprises at least one tab and is integrally mounted in a substantially tubular flexible structure by inserting the tab in at least one tab accepting area. The structure includes a front side having a face portion and a back side having an inner surface, a top side and a bottom side. The front side opposes the back side. The top side and the bottom side are flexible. The face portion of the structure defines an eye area, a nose area and at the least one tab accepting area. At least one image is deposited on the inner surface, opposite the face portion. In one aspect of the invention, the deposited image consists of one or more pictures attached to the structure or ink printed onto the structure. In another step of the method, the image is focussed by compressing the top side and the bottom side, thereby varying a distance between the front and back sides.

In one aspect of the invention, a first image and a second image are deposited on the inner surface. The first image is disposed next to the second image, and oriented on the inner surface substantially level with the second image relative to the bottom side. In another aspect of the invention, two magnifying lenses are provided and connected with a bridge. The tab is held in the tab accepting area by a force supplied by a bending of the bridge. In a further aspect of the invention, when the first and second images are viewed through the two magnifying lenses, a single three-dimensional image is presented to the viewer.

The present invention is further directed to a greeting card for viewing an image. The greeting card includes a substantially tubular flexible structure comprising a front side having a face portion and a back side having an inner surface, wherein the front side opposes the back side. The greeting card also includes a top side and a bottom side, wherein the top side and the bottom side are flexible. The face portion of the structure defines an eye area and a nose area. At least one image is deposited on the inner surface, opposite the face portion. At least one magnifying lens mounted in the eye area. The image is brought into focus by compressing the top side and the bottom side, thereby varying a distance between the front and back sides.

Additionally, the present invention is directed to a method of creating a greeting card for viewing an image. In one step of the invention, a substantially tubular flexible structure is provided which comprises a front side having a face portion and a back side having an inner surface, wherein the front side opposes the back side. The structure also includes a top side and a bottom side, wherein the top side and the bottom side are flexible. The face portion of the structure defines an eye area and a nose area. In another step of the invention, at least one image is deposited on the inner surface, opposite the face portion. In a further step, at least one magnifying lens is integrally mounting in the eye area. The image is brought into focus by compressing the top side and the bottom side, thereby varying a distance between the front and back sides.

The present invention is also directed to a method for viewing an image through a greeting card. The method includes the step of placing one or more eyes of a human in near contact with at least one magnifying lens wherein the at least one lens is mounted in an eye area of a substantially tubular flexible structure. The structure comprises a front side having a face portion and a back side having an inner surface, wherein the front side opposes the back side, a top side and a bottom side, wherein the face portion comprises the eye area. The top side and the bottom side are flexible. At least one image is deposited on the inner surface, opposite the face portion. In another step, the image is focussed by compressing the top side and the bottom side, thereby varying a distance between the front and back sides.

### BRIEF DESCRIPTION OF THE DRAWINGS

The accompanying drawings, wherein like reference numerals are employed to designate like parts or steps, are included to provide a further understanding of the invention, are incorporated in and constitute a part of this specification, and illustrate embodiments of the invention that together with the description serve to explain the principles of the invention.

In the drawings:

FIG. 1A is a front view of a front side of a greeting card in accordance with the present invention;

FIG. 1B is a cross-sectional view of the greeting card shown in FIGS. 1A, 1C, 1D and 2;

FIG. 1C is a back view of the front side of the greeting card shown in FIG. 1A;

FIG. 1D is a front view of a back side of a greeting card in accordance with the present invention;

FIG. 1E is a cross-sectional view of a greeting card in accordance with the present invention;

FIG. 1F is a cross-sectional view of a greeting card in accordance with the present invention;

FIG. 1G is a cross-sectional view of a greeting card in accordance with the present invention;

FIG. 2 depicts an isometric view of a greeting card according to the present invention;

FIGS. 3A and 3B depict alternative embodiments of the lenses used in connection with the greeting card of the present invention;

FIG. 4 is a flow chart showing a method of creating a greeting card of the present invention; and

FIG. 5 is a flow chart showing a method of viewing an image using a greeting card of the present invention.

### DETAILED DESCRIPTION

Reference will now be made in detail to the preferred embodiments of the present invention, examples of which are illustrated in the accompanying drawings. It is to be understood that the Figures and descriptions of the present invention included herein illustrate and describe elements that are of particular relevance to the present invention, while eliminating, for purposes of clarity, other elements.

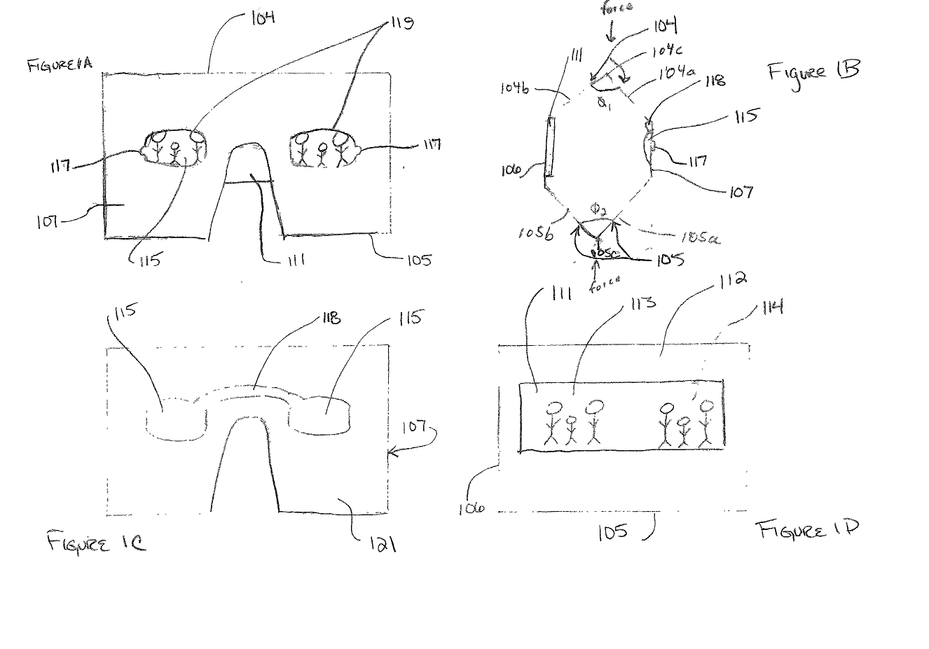

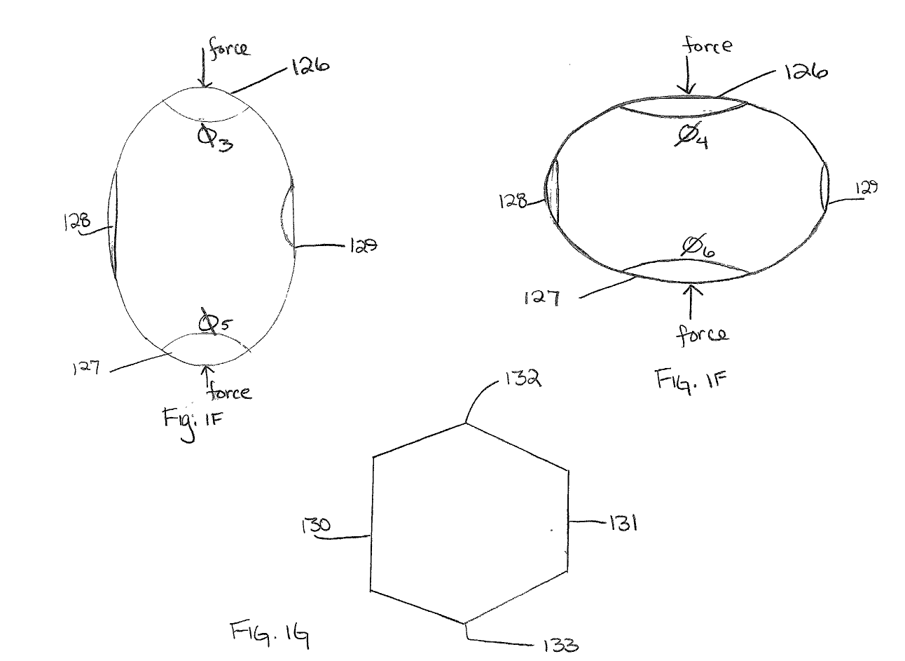

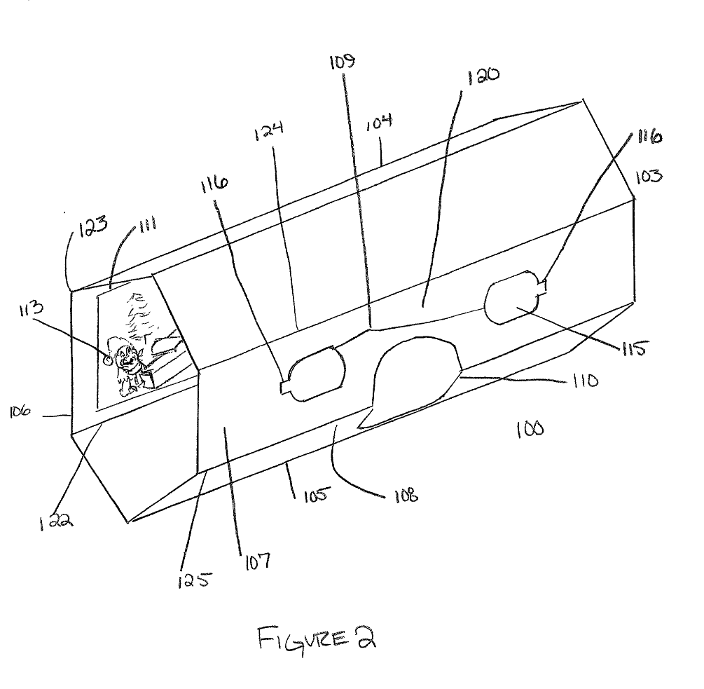

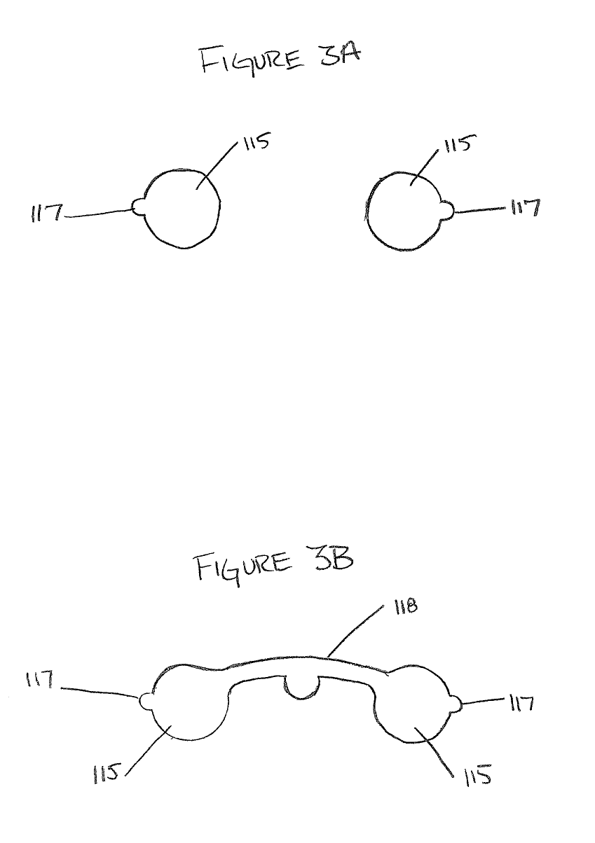

One embodiment of the present invention is described with reference to FIGS. 1A, 1B, 1C, 1D, and 2. FIG. 1A shows a front view of the front side 107 of greeting card 100. FIG. 1B shows a cross-sectional view of greeting card 100. FIG. 1C shows the back view of the front side 107 of the greeting card from the view point of the back side 106. FIG. 1D shows a front view of back side 106, depicting the inner surface 112 of greeting card 100. FIG. 2 shows an isometric view of greeting card 100.

The greeting card 100 is substantially tubular in shape, and made of a material (such as, for example, plastic, paper or light cardboard), which allows greeting card 100 to flex when pressed from one or more of its sides. In the embodiment shown, greeting card 100 is formed from folded paper or cardboard, and includes six substantially planar sides, namely, front side 107, back side 106, top side 104 (formed from surfaces 104a, 104b), and bottom side 105 (formed from surfaces 105a, 105b). Sides 104a, 104b are joined by fold 104c; sides 105a, 105b are joined by fold 105c. Top side 104 and bottom side 105 flex outwardly (causing θ₁, and θ₂ to increase in angle) when a compressive force (as depicted by the arrows in FIG. 1B) is applied at or near folds 104c, 105c, thereby contributing to the flexibility of the greeting card 100. With reference to FIG. 2, folds 122, 123, 124, and 125 also add to the flexibility of the greeting card 100. As the angles θ₁ and θ₂ increase, the distance between front and back sides 107, 106 increases, thereby allowing for adjustment of focus in the present invention.

While the greeting card 100 shown in FIG. 2 is substantially tubular with a hexagonal end shape, it will be known to those skilled in the art that other end shapes (i.e. shapes having more sides, less sides or rounded sides) can be employed in other embodiments in keeping with the present invention. In one alternative, as shown with reference to FIG. 1G, which depicts a cross section of one embodiment of the greeting card of the present invention, the end shape includes ten planar surfaces and includes top side 132, bottom side 133, front side 131 and back side 130. In another example, with reference to FIG. 1E, which depicts a cross section of one embodiment of the greeting card of the present invention, the cross section is oval in shape. When a compressive force (as shown by the arrows in FIG. 1E) is applied near top side 126 and bottom side 127, θ₃, and θ₅ increase in angle to θ₄, and θ₆, as shown in FIG. 1F. As the angles θ₃ and θ₅ increase to θ₄, and θ₆, the distance between front and back sides 128, 129 increases, thereby allowing for adjustment of focus in the present invention.

With reference to FIG. 2, face portion 108 includes eye area 109, nose area 110 and tab accepting areas 116. Face portion 108 may, in some embodiments, extend beyond fold 125 and fold 124. While two eye areas 109 are shown in FIG. 2, one or more eye areas 109 may be used in accordance with the present invention. Similarly, while two tab accepting areas 116 are shown in the FIG. 2, fewer or more tab accepting areas may be used in keeping with the present invention. Moreover, while in the embodiment shown in FIG. 2, tab accepting areas 116 are shown as integral with eye areas 109, tab accepting areas 116 may be located anywhere on the face portion 108 of the front side 107 of greeting card 100.

At least one image 111 is deposited on the inner surface 112 of the greeting card 100. With reference to FIG. 1D, a portion of inner surface 112 is shown and the entire image 111 can be seen. As shown in FIG. 1D, image 111 comprises a first image 113 and a second image 114. In this embodiment, first image 113 is disposed next to second image 114 and is oriented on inner surface 112 substantially level with the second image 114 relative to the bottom side 105. In other embodiments, the image 111 may comprise only a single image or may include more than two images. In one embodiment, image 111 may be one or more sheets separate from inner surface 112 and attached to inner surface 112 by some form of adhesive. In other embodiments, image 111 may be printed on inner surface 112. In some embodiments, the first and second images are identical and, in other embodiments, differences exist between the images.

With reference to FIG. 3A, two magnifying lenses 115 are shown. In a preferred embodiment, the magnification of such lenses is 1.6; however, the magnification may, in other embodiments, range from 1.5 to 2.0. Such lenses include one or more tabs 117. In an alternative embodiment, with reference to FIG. 3B, the lenses 115 may be connected by bridge 118. With reference to FIGS. 1A, 1B and 1C, lenses 115, tabs 117 and bridge 118 are shown. In the preferred embodiment, lenses 115 such as those shown in FIG. 3A or 3B, are integrally mounted in the face portion 108 of the front side 107 of the greeting card 100 by inserting tabs 117 into tab accepting area 116 as seen in FIG. 2. As shown in FIG. 1C, lenses 115 which are connected by bridge 118 are inserted into the greeting card 100. For embodiments in which the lenses 115 are arranged as in FIG. 3B, bridge 118 is compressed, thereby bending it to allow for easy insertion and mounting of tabs 117 into tab accepting area 116. In alternative embodiments, the one or more lenses 115 are mounted in greeting card 110 by an alternative method, such as adhering them to the inner surface 121 (as shown in FIG. 1C) or outer surface 120 (as shown in FIG. 2) of greeting card 100 in eye area 109.

In the preferred embodiments, the lenses 115 may be used to aid in viewing the image 111 in three dimensions. Also, in a preferred embodiment, focussing the image 111 is accomplished by compressing top side 104 and bottom side 105.

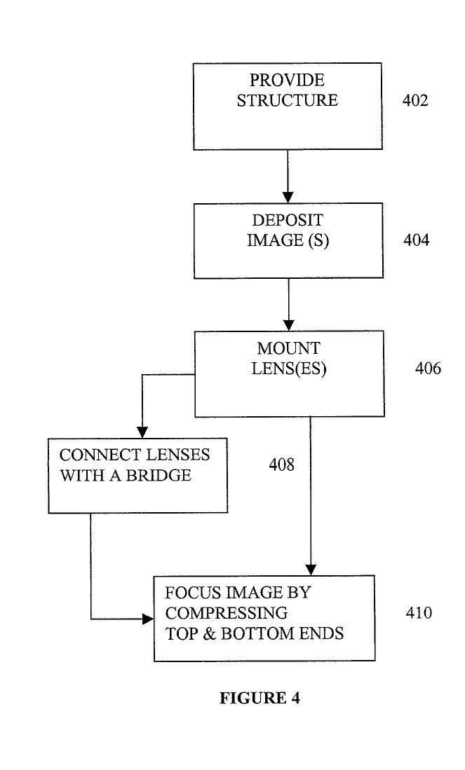

With reference to FIG. 4, a flow chart of a method for creating a greeting card (described with reference to FIGS. 1A-1D, 2 and 3A-3B) for viewing an image is shown. In step 402, a substantially tubular flexible structure is provided, which includes a front side having a face portion and a back side having an inner surface (wherein the front side opposes the back side), a top side and a bottom side. The top side and the bottom side are flexible. The face portion defines an eye area, a nose area and at least one tab accepting area. In step 404, at least one image is deposited on the inner surface, opposite the face portion. The image may be adhered to the inner surface or printed on the inner surface. In step 406, at least one magnifying lens (which includes at least one tab) is integrally mounted in the structure by, for example in one embodiment, inserting the tab in the tab accepting area.

In some embodiments, in step 404, a first image and a second image are deposited on the inner surface, wherein the first image is disposed next to the second image, and oriented on the inner surface substantially level with the second image relative to the bottom side. In other embodiments, step 406 includes integrally mounting in the structure two lenses and includes the additional step 408 of connecting the two lenses with a bridge, wherein the at least one tab is inserted into the at least one tab accepting area by bending the bridge. In additional embodiments, in step 410, the viewed image is brought into focus by compressing the top side and the bottom side, thereby varying the distance between the front and back sides. The top side and the bottom side may be formed of planar surfaces. In some embodiments, when the first and second images are viewed through the two magnifying lenses, a single three-dimensional image is presented to a viewed.

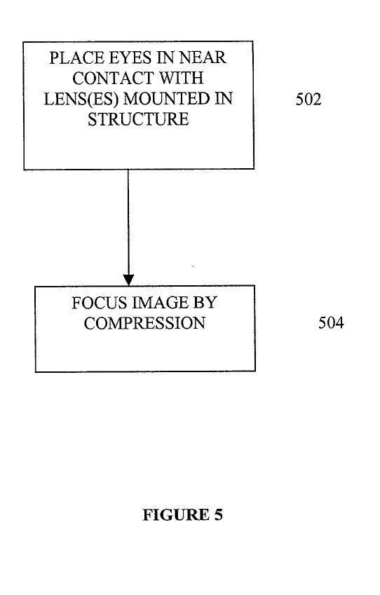

With reference to FIG. 5, a flow chart depicting a method for viewing an image through a greeting card (described with reference to FIGS. 1A-1D, 2 and 3A-3B) is shown. In step 502, one or more eyes of a human are placed in near contact with at least one magnifying lens (which includes at least one tab) which is integrally mounted in a substantially tubular flexible structure. The structure includes a front side having a face portion and a back side having an inner surface (wherein the front side opposes the back side), a top side and a bottom side. At least one image is deposited on the inner surface, opposite the face portion. The image may be adhered to the inner surface or printed on the inner surface. The face portion of the structure defines an eye area, a nose area and at least one tab accepting area. The magnifying lens is integrally mounted in the structure, for example in one embodiment, by inserting the tab in the tab accepting area. In step 504, the image is focused by compressing the top side and the bottom side, thereby varying the distance between the front and back sides.

In alternative embodiments, in step 502, a first image and a second image are deposited on the inner surface. The first image is disposed next to the second image, and oriented on the inner surface substantially level with the second image relative to the bottom side. In a further embodiment, step 502 includes placing one or more eyes of a human in near contact with two magnifying lenses, which are connected with a bridge. The tab is held in the tab accepting area by a force supplied by a bending of the bridge. In some embodiments, when the first and second images are viewed through the two magnifying lenses, a single three-dimensional image is presented to the viewer.

While the invention has been described in detail and with reference to specific embodiments thereof, it will be apparent to one skilled in the art that various changes and modifications can be made therein without departing from the spirit and scope thereof. Thus, it is intended that the present invention cover the modifications and variations of this invention provided they come within the scope of the appended claims and their equivalents.

What is claimed is:

1. A greeting card for viewing an image comprising:
a substantially tubular flexible structure comprising a front side having a face portion and a back side having an inner surface, wherein said front side opposes said back side, a top side and a bottom side,
wherein said top side and said bottom side are flexible; and
wherein said face portion defines an eye area, a nose area and at least one tab accepting area;
at least one image deposited on said inner surface, opposite said face portion; and
at least one magnifying lens;
wherein said at least one lens comprises at least one tab; and
wherein said at least one lens is integrally mounted in said structure by inserting said tab in said tab accepting area.

2. The greeting card of claim 1 wherein a first image and a second image are deposited on said inner surface, wherein said first image is disposed next to said second image, and oriented on said inner surface substantially level with said second image relative to said bottom side.

3. The greeting card of claim 2 wherein said greeting card comprises two magnifying lenses, and further comprises a bridge connecting said two lenses and wherein said at least one tab is held in said at least one tab accepting area by a force supplied by a bending of said bridge.

4. The greeting card of claim 3 wherein when said first and second images are viewed through the two magnifying lenses, a single three-dimensional image is presented to a viewer.

5. The greeting card of claim 1 wherein said image deposited on said inner surface comprises one or more pictures attached to said structure.

6. The greeting card of claim 1 wherein said image deposited on said inner surface comprises ink printed onto said structure.

7. The greeting card of claim 1 wherein said image is brought into focus by compressing said top side and said bottom side and thereby varying a distance between said front and back sides.

8. The greeting card of claim 1 wherein the substantially tubular structure is formed of six planar surfaces.

9. A method of creating a greeting card for viewing an image comprising the steps of:
(A) providing a substantially tubular flexible structure comprising a front side and a back side having an inner surface, wherein said front side opposes said back side, having a face portion, a top side and a bottom side,
wherein said top side and said bottom side are flexible; and
wherein said face portion defines an eye area, a nose area and at least one tab accepting area;
(B) depositing at least one image on said inner surface, opposite said face portion; and
(C) integrally mounting in said structure at least one magnifying lens;
wherein said at least one lens comprises at least one tab; and
wherein said at least one lens is integrally mounted in said structure by inserting said tab in said tab accepting area.

10. The method of claim 9 wherein, in step (B), a first image and a second image are deposited on said inner surface, wherein said first image is disposed next to said second image, and oriented on said inner surface substantially level with said second image relative to said bottom side.

11. The method of claim 10 wherein step (C) comprises integrally mounting in said structure two lenses and comprising the further step of:
(D) connecting said two lenses with a bridge, wherein said at least one tab is inserted into said at least one tab accepting area by bending said bridge.

12. The method of claim 11 wherein when said first and second images are viewed through the two magnifying lenses, a single three-dimensional image is presented to a viewer.

13. The method of claim 9 wherein said image deposited on said inner surface comprises one or more pictures attached to said structure.

14. The method of claim 9 wherein said image deposited on said inner surface comprises ink printed onto said structure.

15. The method of claim 9, wherein said top side and said bottom side are formed of planar surfaces.

16. The method of claim 9 comprising the further step of:
(D) focussing said image by compressing said top side and said bottom side, thereby varying a distance between the front and back sides.

17. A method for viewing an image through a greeting card comprising the steps of:
(A) placing one or more eyes of a viewer in near contact with at least one magnifying lens
wherein said at least one lens comprises at least one tab;
wherein said at least one lens is integrally mounted in a substantially tubular flexible structure by inserting said tab in at least one tab accepting area,
wherein said structure comprises a front side having a face portion and a back side having an inner surface, a top side and a bottom side, wherein said front side opposes said back side,
wherein said top side and said bottom side are flexible,
wherein said face portion of said structure defines an eye area, a nose area and at the least one tab accepting area;
wherein at least one image is deposited on said inner surface, opposite said face portion; and
(B) focussing said image by compressing said top side and said bottom side, thereby varying a distance between said front and back sides.

18. The method of claim 17 wherein, in step (A), a first image and a second image are deposited on said inner surface, wherein said first image is disposed next to said second image, and oriented on said inner surface substantially level with said second image relative to said bottom side.

19. The method of claim 18 wherein step (A) comprises placing one or more eyes of the viewer in near contact with two magnifying lenses; wherein said two lenses are connected with a bridge; and wherein said at least one tab is held in said at least one tab accepting area by a force supplied by a bending of said bridge.

20. The method of claim 19 when said first and second images are viewed through the two magnifying lenses, a single three-dimensional image is presented to the viewer.

21. The method of claim 17 wherein said image deposited on said inner surface comprises one or more pictures attached to said structure.

22. The method of claim 17 wherein said image deposited on said inner surface comprises ink printed onto said structure.

23. A greeting card for viewing an image comprising:
a substantially tubular flexible structure comprising a front side having a face portion and a back side having an inner surface, wherein said front side opposes said back side, a top side and a bottom side,
wherein said top side and said bottom side are flexible; and
wherein said face portion of said structure defines an eye area and a nose area; at least one image deposited on said inner surface, opposite said face portion; and at least one magnifying lens mounted in said eye area;
wherein said image is brought into focus by compressing said top side and said bottom side, and thereby varying a distance between said front and back sides.

24. A method of creating a greeting card for viewing an image comprising the steps of:
(A) providing a substantially tubular flexible structure comprising a front side having a face portion and a back side having an inner surface, wherein said front side opposes said back side, a top side and a bottom side,
wherein said top side and said bottom side are flexible; and
wherein said face portion of said structure defines an eye area and a nose area;
(B) depositing at least one image on said inner surface, opposite said face portion; and
(C) integrally mounting in said eye area at least one magnifying lens;
wherein said image is brought into focus by compressing said top side and said bottom side, and thereby varying a distance between said front and back sides.

25. A method for viewing an image through a greeting card comprising the steps of:
(A) placing one or more eyes of a human in near contact with at least one magnifying lens wherein said at least one lens is mounted in an eye area of a substantially tubular flexible structure,
wherein said structure comprises a front side having a face portion and a back side having an inner surface, wherein said front side opposes said back side, a top side and a bottom side, wherein the face portion comprises said eye area,
wherein said top side and said bottom side are flexible; and
wherein at least one image is deposited on said inner surface, opposite said face portion;
(B) focussing said image by compressing said top side and said bottom side, and thereby varying a distance between said front and back sides.
